(19) United States
(12) Patent Application Publication
(10) Pub. No.: US 2024/0189768 A1
(43) Pub. Date: Jun. 13, 2024

(54) Methods and Compositions for the Sequestration of Carbon Dioxide

(71) Applicant: CARBONFREE CHEMICALS HOLDINGS, LLC, San Antonio, TX (US)

(72) Inventor: Joe JONES, San Antonio, TX (US)

(73) Assignee: CARBONFREE CHEMICALS HOLDINGS, LLC, San Antonio, TX (US)

(21) Appl. No.: 18/555,253

(22) PCT Filed: Apr. 14, 2022
(86) PCT No.: PCT/US2022/071726

§ 371 Date: Oct. 12, 2023

Related U.S. Application Data
(60) Provisional application No. 63/174,977, filed on Apr. 14, 2021.

(51) Int. Cl. B01D 53/62; B01D 53/78; C01F 5/24

(52) U.S. Cl. CPC B01D 53/62; B01D 53/78; C01F 5/24; B01D 2251/402; B01D 2258/0283

(57) ABSTRACT

The present invention relates to methods for capturing carbon dioxide and permanently sequestering carbon dioxide in the form of Group II metal carbonates. The invention involves production of HCl by reacting steam with a material that includes a magnesium chloride hydrate. The HCl that is generated from this process is used to leach Group II mineral salts from a variety of different materials, including minerals and industrial waste materials. The leached Group II mineral salts are used to capture carbon dioxide by forming Group II mineral salt carbonates.

### CROSS-REFERENCE TO RELATED APPLICATIONS

This application claims the benefit of priority to U.S. Provisional Patent Application Ser. No. 63/174,977, filed Apr. 14, 2021, hereby incorporated by reference in its entirety.

### FIELD OF THE INVENTION

The invention relates generally to the reduction of carbon dioxide in the atmosphere and, more particularly, to the capture and sequestration of carbon dioxide.

### BACKGROUND

Increased global warming due to the presence and production of greenhouse gases such as carbon dioxide, makes the capture and permanent sequestration of carbon dioxide by economical means imperative.

Carbon dioxide capture and storage (CCS) has the potential to significantly reduce greenhouse gas emissions from industries that rely on combustion processes, such as power generation plants and cement production facilities. Unfortunately, capturing carbon dioxide via CCS is energy intensive due to thermal energy requirements, as well as the need to compress captured carbon dioxide for subsurface storage. This energy demand can reduce net output from power plants by more than 20%.

Gas companies use the amine scrubbing process to separate carbon dioxide from methane, and a very similar process can be used to remove carbon dioxide from flue gas. The major problem with the amine scrubbing process is that the regeneration of the amine solution and the subsequent compression of carbon dioxide is very energy intensive. As a consequence, equipping a power plant with amine-based carbon capture leads to a reduction in efficiency as high as 35%.

An alternative CCS method involves an oxy-combustion process in which coal is burned in the presence of pure oxygen to produce the combustion products carbon dioxide and water. CO₂ is then captured by condensing the water from the carbon dioxide/water mixture. The pure oxygen used in the oxy-combustion is obtained from an energy intensive air separation process that involves cryogenically cooling air into liquid form and distilling pure oxygen from nitrogen in the liquid air.

Given the reliance on fossil fuels, widespread adoption of CCS is imperative for reduction of greenhouse gases and control of global warming. Although some companies are focused on finding alternative CCS processes, a significant amount of research is focused on increasing the efficiency of current carbon dioxide-capture processes.

### SUMMARY

It is an object of the present invention to provide a method for the absorption and separation of carbon dioxide that overcomes many of the disadvantages of the prior art. The inventor has identified methods for the production of mineral ion salts that can be used to sequester carbon dioxide in the form of mineral ion carbonate salts. The mineral ion salts can be obtained from different sources, including industrial waste materials and various geological silicate minerals.

Some embodiments of the disclosure are directed to a method of employing a waste material to sequester carbon dioxide. In some embodiments, the method comprises the steps of reacting a magnesium chloride hydrate-containing material with steam to generate hydrochloric acid and magnesium hydroxide, contacting the magnesium hydroxide with a gas stream comprising carbon dioxide to provide a partially or fully carbonated stream, contacting waste material with the hydrochloric acid and optionally water to leach mineral ion salts from the waste material into a brine or slurry, recovering the mineral ion salts from the brine or slurry, and reacting the mineral ions salts with the partially or fully carbonated stream to sequester carbon dioxide in the form of mineral ion carbonate salts. In some embodiments, the partially or fully carbonated stream comprises Mg(OH)ₓ(HCO₃)_{y}, where x+y=2. In some embodiments, the mineral ion carbonate salts comprise precipitated calcium carbonate (PCC). In some embodiments, the mineral ion carbonate salts further comprise lesser value, mixed carbonates.

Some embodiments of the disclosure are directed to a method of employing a geological silicate mineral to sequester carbon dioxide. In some embodiments, the method comprises the steps of reacting a magnesium chloride hydrate-containing material with steam to generate hydrochloric acid and magnesium hydroxide, contacting the magnesium hydroxide with a gas stream comprising carbon dioxide to provide a partially or fully carbonated stream, contacting the geological silicate mineral with the hydrochloric acid and optionally water to leach mineral ion salts from the geological silicate mineral into a brine or slurry, recovering the mineral ion salts from the brine or slurry, reacting the mineral ions salts with the partially or fully carbonated stream to sequester carbon dioxide in the form of mineral ion carbonate salts. In some embodiments, the partially or fully carbonated stream comprises Mg(OH)ₓ(HCO₃)_{y}, where x+y=2. In some embodiments, the mineral ion carbonate salts comprise precipitated calcium carbonate. In some embodiments, the mineral ion carbonate salts further comprise lesser value, mixed carbonates.

In some embodiments, the mineral ion salts comprise at least one Group II metal cation. In some embodiments, the Group II metal cation is a calcium cation. In some embodiments, the Group II metal cation is a magnesium cation. In some embodiments, the waste material is an industrial waste material. In some embodiments, the industrial waste material is selected from the group consisting of masonry, concrete, steel furnace slag, bio-mass fuel production slag, and waste coal fly ash.

In some embodiments, the carbon dioxide is a component of a flue gas stream. In some embodiments, the carbon dioxide is atmospheric carbon dioxide. In some embodiments, the step of contacting the waste material with the hydrochloric acid is performed at ambient temperature. In some embodiments, the step of contacting the waste material with the hydrochloric acid is performed at greater-than-ambient temperature. In some embodiments, the step of contacting the waste material with the hydrochloric acid is performed at ambient pressure.

In some embodiments, the step of contacting the waste material with the hydrochloric acid does not involve mechanical agitation or abrasion of solids. In some embodiments, the step of contacting the waste material with the hydrochloric acid involves mechanical agitation or abrasion of solids. In some embodiments, the step of contacting the waste material with the hydrochloric acid further comprises recirculating liquids to increase contact between the waste material and the hydrochloric acid.

In some embodiments, the step of contacting the geological silicate mineral with the hydrochloric acid is performed at ambient temperature. In some embodiments, the step of contacting the geological silicate mineral with the HCl is performed at greater-than-ambient temperature. In some embodiments, the step of contacting the geological silicate mineral with the hydrochloric acid is performed at ambient pressure. In some embodiments, the step of contacting the geological silicate mineral with the hydrochloric acid is performed at greater-than-ambient pressure.

In some embodiments, the step of contacting the geological silicate mineral with the hydrochloric acid does not involve mechanical agitation or abrasion of solids. In some embodiments, the step of contacting the geological silicate mineral with the hydrochloric acid involves mechanical agitation or abrasion of solids. In some embodiments, the step of contacting the geological silicate mineral with the hydrochloric acid further comprises recirculating liquids to increase contact between the geological silicate mineral and the hydrochloric acid.

In some embodiments, mineral ion salts present in brine or slurry are recovered. In some embodiments, the brine or slurry is transferred to a settling tank. In some embodiments, solids in the brine or slurry are allowed to settle at the bottom of the settling tank. In some embodiments, the brine or slurry is transferred to an evaporation pond. In some embodiments, liquid in the brine or slurry is allowed to evaporate. In some embodiments, solar energy and/or naturally occurring wind are harnessed to increase the rate of evaporation. In some embodiments, non-renewable energy is not used to increase the rate of evaporation. In some embodiments, no energy is provided to the evaporation pond to increase the rate of evaporation.

In some embodiments, the mineral ion salts comprise at least one Group II metal cation. In some embodiments, the Group II metal cation is a calcium cation. In some embodiments, the Group II metal cation is a magnesium cation. In some embodiments, the geological silicate mineral is selected from the group consisting of olivine, forsterite, pyrope, spessartine, grossular, andradite, uvarovite, hydrogrossular, norbergite, chondrodite, humite, clinohumite, datolite, titanite, chloritoid, lawsonite, axinite, ilvaite, epidote, zoisite, tanzanite, clinozoisite, allanite, dollaseite, vesuvianite, paopgoite, tourmaline, osumilite, cordierite, sekaninaite, cudialyte, milarite, enstatite, pigeonite, diopside, hedenbergite, augite, proxferroite, wollastonite, pectolite, anthophyllite, cummingtonite, tremolite, actinolite, hornblende, glaucophane, arfvedsonite, antigorite, chrysotile, lizardite, talc, illite, montmorillonite, chlorite, vermiculite, sepiolite, palygorskite, biotite, phlogopite, margarite, glauconite, oligoclase, andesine, labradorite, bytownite, anorthite, cancrinite, hauyne, lazurite, erionite, chabazite, heulandite, stilbite, scolecite, mordenite, clinoenstatite, and combinations thereof.

It is specifically contemplated that any limitation discussed with respect to one embodiment of the invention may apply to any other embodiment of the invention. Furthermore, any composition of the invention may be used in any method of the invention, and any method of the invention may be used to produce or to utilize any composition of the invention.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a block diagram of a carbon dioxide sequestration process according to some embodiments of the present invention.

### DETAILED DESCRIPTION

The present invention relates to methods for capturing carbon dioxide and permanently sequestering carbon dioxide in the form of metal carbonates. The invention involves production of HCl by reacting steam with a material that includes a magnesium chloride hydrate. The HCl that is generated from this process is used to leach mineral salts from a variety of different materials, including minerals and industrial waste materials. The leached mineral salts are used to capture carbon dioxide by forming carbonates of mineral salt cations.

Of the numerous mineral salts that are available, Group II salts are generally employed for CO₂ capture. The Group II metals calcium and magnesium are relatively abundant throughout the world in various geological mineral deposits and in industrial waste materials. The abundant calcium and magnesium-containing minerals and waste materials provide a relatively inexpensive feedstock for CO₂-sequestering chemicals.

### A. Definitions

As used herein, the terms “carbonates” or “carbonate products” are generally defined as mineral components containing the carbonate group, [CO₃]²⁻. Thus, the terms encompass both carbonate/bicarbonate mixtures and species containing solely the carbonate ion. The terms “bicarbonates” and “bicarbonate products” are generally defined as mineral components containing the bicarbonate group, [HCO₃]¹⁻. Thus, the terms encompass both carbonate/bicarbonate mixtures and species containing solely the bicarbonate ion.

As used herein “Ca/Mg” signifies either Ca alone, Mg alone or a mixture of both Ca and Mg. The ratio of Ca to Mg may range from 0:100 to 100:0, including, e.g., 1:99, 5:95, 10:90, 20:80, 30:70, 40:60, 50:50, 60:40, 70:30, 80:20, 90:10, 95:5, and 99:1. The symbols “Ca/Mg”, “MgₓCa₍₁₋ₓ₎” and “CaₓMg₍₁₋ₓ₎” are synonymous. The phrases “Group II” and “Group 2” are used interchangeably. A hydrate of magnesium chloride refers to any hydrate, including but not limited to hydrates that have 2, 4, 6, 8, or 12 equivalents of water per equivalent of magnesium chloride. Based on the context, the abbreviation “MW” either means molecular weight or megawatts. The abbreviation “PFD” is process flow diagram. The abbreviation “Q” is heat (or heat duty), and heat is a type of energy. This does not include any other types of energy.

As used herein, the term “sequestration” is used to refer generally to techniques or practices whose partial or whole effect is to remove CO₂ from point emissions sources and to store that CO₂ in some form so as to prevent its return to the atmosphere. Use of this term does not exclude any form of the described embodiments from being considered sequestration” techniques.

The use of the word “a” or “an,” when used in conjunction with the term “comprising” in the claims and/or the specification may mean “one,” but it is also consistent with the meaning of “one or more.” “at least one,” and “one or more than one.”

Throughout this application, the term “about” is used to indicate that a value includes the inherent variation of error for the device, the method being employed to determine the value, or the variation that exists among the study subjects.

The terms “comprise,” “have” and “include” are open-ended linking verbs. Any forms or tenses of one or more of these verbs, such as “comprises,” “comprising.” “has.” “having.” “includes” and “including.” are also open-ended. For example, any method that “comprises,” “has” or “includes” one or more steps is not limited to possessing only those one or more steps and also covers other unlisted steps.

The above definitions supersede any conflicting definition in any of the reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

### B. Sequestration of CO₂ Using Group II Salts Leached From Geological Minerals or Industrial Waste Materials

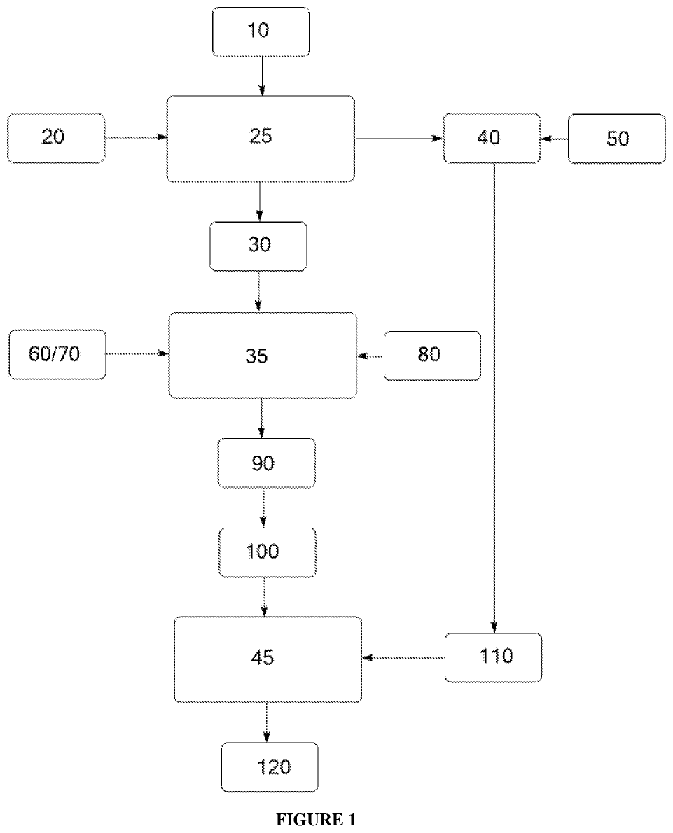

FIG. 1 depicts a simplified process-flow diagram illustrating general, exemplary embodiments of the apparatuses and methods of the present disclosure. This diagram is offered for illustrative purposes only, and thus it merely depicts specific embodiments of the present invention and is not intended to limit the scope of the claims in any way.

Methods for capturing carbon dioxide are disclosed herein. Referring to FIG. 1, the methods involve a first step of reacting steam 10 with a magnesium chloride hydrate-containing material 20 in reactor 25 to generate HCl 30 and Mg(OH)₂ 40. The magnesium chloride hydrate-containing material 20 may comprise magnesium chloride in dihydrate, tetrahydrate, hexahydrate, octahydrate, dodecahydrate, or other hydrated form. Decomposition of a magnesium chloride hydrate produces Mg(OH)₂ 40 and HCl 30. This internally-generated HCl 30 may be in the form of HCl gas, a solution of HCl in water, or a gaseous solution of HCl in steam.

The Mg(OH)₂ 40 is contacted with a gas stream comprising carbon dioxide 50 to provide a partially or fully carbonated stream 110. The partially or fully carbonated stream 110 comprises the reaction product of Mg(OH)₂ 40 and carbon dioxide 50, Mg(OH)ₓ(HCO₃)_{y} where x+y=2.

The HCl 30 is sent to reactor 35 where it contacts industrial waste material 40 and/or geological silicate mineral 50. Water 80, in liquid or gaseous form can optionally be provided to reactor 35. Contacting of the industrial waste material 60 and/or geological silicate mineral 70 with HCl 30 can be performed under ambient pressure. Alternatively, contacting of the industrial waste material 60 and/or geological silicate mineral 70 with HCl 30 can be performed under greater-than-ambient pressure. Contacting of the industrial waste material 60 and/or geological silicate mineral 70 with HCl 30 can be performed under ambient temperature. Alternatively, contacting of the industrial waste material 60 and/or geological silicate mineral 70 with HCl 30 can be performed under greater-than-ambient temperature. The concentration of HCl 30 in reactor 35 can be controlled by adjusting conditions in reactor 25, and/or by adjusting the time and/or rate at which HCl 30 is provided to reactor 35. By controlling HCl concentration in reactor 35, the incorporation of chloride into various SiO complexes can be controlled or avoided.

HCl 30 and industrial waste material 60 and/or geological silicate mineral 70 can be allowed to react in reactor 35 without mechanical agitation or abrasion of solids. HCl 30 and industrial waste material 60 and/or geological silicate mineral 70 in reactor 35 can be subjected to mechanical agitation and/or abrasion of solids. Liquid in reactor 35 can be recirculated to increase contact between industrial waste material 60 and/or geological silicate mineral 70 and HCl 30.

Contacting of the industrial waste material 60 and/or geological silicate mineral 70 with HCl 30 allows the HCl 30 to react with industrial waste material 60 and/or geological silicate mineral 70 and leach mineral ion salts from the waste material into a brine or slurry 90. The brine or slurry 90 is recovered, and this brine or slurry contains mineral ion salts from industrial waste material 60 and/or geological silicate mineral 70. The mineral ion salts present brine or slurry 90 can be in solution, in solid form, or a combination of solution and undissolved solid.

The mineral ion salts 100 present in brine or slurry 90 are recovered. A variety of methods can be employed to aid in recovery of mineral ion salts 100 present from brine or slurry 90. The brine or slurry 90 can be transferred to a settling tank. Solids within brine or slurry 90 can be allowed to settle at the bottom of the settling tank. Alternatively, sand filters can be employed to remove solids from brine or slurry 90. The brine or slurry 90 can be transferred to an evaporation pond where liquid in the brine or slurry 90 is allowed to evaporate. Solar energy and/or naturally-occurring wind can be harnessed to increase the rate of evaporation. In some embodiments, non-renewable energy is not used to increase the rate of evaporation. In some embodiments, no energy is provided to the evaporation pond to increase the rate of evaporation. The brine or slurry 70 can be transferred to an evaporation system. The evaporation system can be a single, double, or triple-effect evaporation system.

The mineral ion salts 100 are reacted with Mg(OH)ₓ(HCO₃)_{y} present in partially or fully carbonated stream 110 to sequester carbon dioxide in the form of mineral ion carbonate salts 120.

### C. Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Evaluation of Materials for Production of PCC

Three industrial waste test materials (blast furnace slag, biomass slag, and coal fly ash) were examined for the production of precipitated calcium chloride (PCC, a precipitated mineral ion salt). The studies were performed to evaluate the use of raw-unimproved brines from the three test sources. Various conditions were examined to test the precipitation process over a range of processing conditions. Process control of temperature-of-precipitation, volumetric-variation of precipitating-salt-to-uptake-fluid, and pH control of the uptake-fluid conditions can be used to increase the precipitation-selectivity of calcium salts over magnesium and iron salts contained within the raw test materials.

The test materials were contacted with hydrochloric acid in recirculating baths to produce brines, and solids were filtered after dissolution. The brines were assayed using SEM/ICP to determine the chemical makeup of dissolved salts. The results provided in Table 1 below demonstrate that brines with high calcium content can be obtained from hydrochloric acid dissolution of various industrial waste materials. These high calcium brines can be used to produce PCC or can be used directly in carbon dioxide sequestration processes.

TABLE 1
Salt Solutions Compositions Index

| Test Material | Ca (wt. %) | Mg (wt. %) | Fe (wt. %) |
|---|---|---|---|
| Blast furnace slag | 88.22 | 11.47 | 0.31 |
| Biomass slag | 86.99 | 9.7 | 3.31 |
| Coal fly ash | 62.77 | 24.69 | 12.54 |

### Example 2

### Dissolution of Waste Material and Capture of CO₂

A sample of MgCl₂ hydrate-containing material was reacted with steam in a decomposition reactor to generate aqueous Mg(OH)₂ and HCl gas. A mixture of unreacted steam and gaseous HCl was collected as an aqueous HCl solution. This solution was diluted to a concentration of 15% and the resulting solution was used to dissolve coal fly ash and biomass slag waste materials. The waste dissolution process involved adding each waste material to a solution of HCl in a separate reactor and monitoring the reaction temperature. Additional water was added to dilute or re-liquefy the dissolution reactions. The biomass slag dissolution reaction involved generation of water vapor and loss of water, therefore, water was added to account for the loss of water. Table 2 below depicts temperatures, volumes, and masses for various waste-dissolution experimental runs.

TABLE 2
Waste dissolution run specifications

| | | Mass | Volume HCl | H₂O Added | Max Temp. |
|---|---|---|---|---|---|
| | Material | (g) | (mL) | (mL) | (° C.) |
| Run 1 | Biomass | 150 | 250 | 80 | 75 |
| Run 2 | Biomass | 120 | 166 | 50 | 75 |
| Run 3 | Coal | 350 | 50 | 100 | 32 |
| Run 4 | Biomass | 120 | 120 | 50 | 76 |
| Run 5 | Biomass | 120 | 130 | 25 | 75 |
| Run 6 | Coal | 487 | 75 | 200 | 35 |
| Run 7 | Biomass | 240 | 240 | 100 | 78 |
| Run 8 | Coal | 423 | 50 | 75 | 35 |

Once the materials were mixed thoroughly and optionally re-liquified with water, the resulting brines and slurries were allowed to sit for 30 minutes to complete any reactions still taking place. During this time, the temperatures of the brines/slurries started decreasing back to ambient temperatures and the pH of the slurries were taken using a calibrated pH meter. Aqueous NH₄OH was added to low-pH samples (<3.5) to raise pH to ≥6. Once the slurries cooled to ambient temperature, solids were filtered from the slurries to provide a cake and filtrate liquid. In some aspects, a brine generated from dissolution of a waste material disclosed above can be used directly without filtration.

A stream of gaseous CO₂ was bubbled through the aqueous Mg(OH)₂ solution generated from steam-driven decomposition of MgCl₂ hydrate to provide a carbonated solution comprising Mg(HCO₃)₂. The carbonated solution was combined with the brines or filtrate liquids produced above to yield products comprising calcium carbonate (solid) and MgCl₂ in solution. The products were filtered to separate the precipitated calcium carbonate (PCC) from the MgCl₂ solutions. Inductively-coupled plasma (ICP) analysis was performed on the PCC collected from runs 7 and 8 in Table 2. The cation compositions are depicted in Table 3 below.

TABLE 3
Calcium carbonate ICP analysis

| Cation | Run 7 (mol/kg) | Run 8 (mol/kg) |
|---|---|---|
| Ca | 10.227 | 9.877 |
| Fe | 0.0002 | 0.053 |
| Mg | 0.448 | 0.987 |
| Na | 0.08 | 0.011 |
| Be | 0.0004 | 0.0036 |
| Ba | 0.0001 | 0.0032 |
| Sr | 0.008 | 0.0421 |
| Mn | 0.032 | 0.045 |

The results in Table 3 above demonstrate that high-purity calcium carbonate can be obtained by harnessing HCl generated from decomposition of a magnesium chloride hydrate-containing material. The HCl was used to dissolve various waste materials to provide brines or slurries with high calcium content. Magnesium hydroxide generated from decomposition of the magnesium chloride hydrate-containing material was carbonated with carbon dioxide gas, and the resulting carbonated solutions were combined with the waste-derived brines or slurries to provide magnesium chloride solutions containing precipitated calcium carbonate. The methods disclosed herein provide novel means by which various waste materials can be recycled and employed as a key component for the environmentally-conscious sequestration of gaseous carbon dioxide. The methods can be extended to the use of geological silicate minerals as an alternative to waste materials.

1. A method of employing a waste material or geological silicate mineral to sequester carbon dioxide, the method comprising:
reacting a magnesium chloride hydrate-containing material with steam to generate HCl and Mg(OH)₂;
contacting the Mg(OH)₂ with a gas stream comprising carbon dioxide to provide a partially or fully carbonated stream comprising Mg(OH)ₓ(HCO₃)_{y} where x+y=2;
contacting waste material or geological silicate mineral with the HCl and optionally water to leach mineral ion salts from the waste material or geological silicate mineral into a brine or slurry;
recovering the mineral ion salts from the brine or slurry; and
reacting the mineral ions salts with the partially or fully carbonated stream to sequester carbon dioxide in the form of mineral ion carbonate salts comprising calcium carbonate.

2. (canceled)

3. The method of claim 1, wherein the mineral ion salts comprise a calcium cation and/or a magnesium cation.

4.-6. (canceled)

7. The method of claim 1, wherein the waste material is selected from the group consisting of masonry, concrete, steel furnace slag, bio-mass fuel production slag, and waste coal fly ash.

8. The method of claim 1, wherein the carbon dioxide is atmospheric carbon dioxide or is a component of a flue gas stream.

9. The method of claim 1, wherein the carbon dioxide is atmospheric carbon dioxide.

10. The method of claim 1, wherein the step of contacting the waste material with the HCl is performed at ambient temperature.

11. The method of claim 1, wherein the step of contacting the waste material with the HCl is performed at ambient pressure.

12. The method of claim 1, wherein the step of contacting the waste material with the HCl does not involve mechanical agitation or abrasion of solids.

13. The method of claim 1, wherein the step of contacting the waste material with the HCl further comprises recirculating liquids to increase contact between the waste material and the HCl.

14. The method of claim 1, further comprising transferring the brine or slurry to a settling tank and allowing solids in the brine or slurry to settle at the bottom of the settling tank.

15. (canceled)

16. The method of claim 1, further comprising transferring the brine or slurry to an evaporation pond and allowing liquid in the brine or slurry to evaporate.

17. (canceled)

18. The method of claim 16, wherein solar energy and/or naturally occurring wind are harnessed to increase the rate of evaporation.

19. The method of claim 16, wherein non-renewable energy is not used to increase the rate of evaporation.

20. The method of claim 16, wherein no energy is provided to the evaporation pond to increase the rate of evaporation.

21.-26. (canceled)

27. The method of claim 1, wherein the geological silicate mineral is selected from the group consisting of olivine, forsterite, pyrope, spessartine, grossular, andradite, uvarovite, hydrogrossular, norbergite, chondrodite, humite, clinohumite, datolite, titanite, chloritoid, lawsonite, axinite, ilvaite, epidote, zoisite, tanzanite, clinozoisite, allanite, dollaseite, vesuvianite, paopgoite, tourmaline, osumilite, cordierite, sekaninaite, eudialyte, milarite, enstatite, pigeonite, diopside, hedenbergite, augite, proxferroite, wollastonite, pectolite, anthophyllite, cummingtonite, tremolite, actinolite, hornblende, glaucophane, arfvedsonite, antigorite, chrysotile, lizardite, talc, illite, montmorillonite, chlorite, vermiculite, sepiolite, palygorskite, biotite, phlogopite, margarite, glauconite, oligoclase, andesine, labradorite, bytownite, anorthite, cancrinite, hauyne, lazurite, erionite, chabazite, heulandite, stilbite, scolecite, mordenite, clinoenstatite, and combinations thereof.

28.-42. (canceled)
